(19) United States
(12) Patent Application Publication
(10) Pub. No.: US 2026/0124105 A1
(43) Pub. Date: May 7, 2026

(54) SPIRAL PULL AND INSERT STRUCTURE OF MASSAGE HEAD

(71) Applicant: Zhejiang Red And Black Technology Co., Ltd., Lishui (CN)

(72) Inventors: Xinyi Shu, Jinyun County (CN); Lifeng Shu, Jinyun County (CN)

(21) Appl. No.: 18/961,172

(22) Filed: Nov. 26, 2024

(30) Foreign Application Priority Data
Nov. 1, 2024 (CN) 2024226680763

(51) Int. Cl. A61H 23/00

(52) U.S. Cl. CPC A61H 23/006; A61H 2201/1664; A61H 2201/1685

(57) ABSTRACT

The present disclosure relates to a spiral pull and insert structure of a massage head, including a massage head, a sliding rod holder, and a screw. A first groove is provided on the massage head. An end of the first groove includes a thread. A second groove is provided on the sliding rod holder. An end of the screw includes a thread. The sliding rod holder is sleeved on the massage head, and the screw is disposed inside the first groove and the second groove. A size of the screw matches a size of the first groove and a size of the second groove. Therefore, the massage head may be mounted and removed rapidly and conveniently, and stability and coaxality of the massage head are ensured during use.

### TECHNICAL FIELD

The present disclosure relates to a field of percussion massagers, and in particular to a spiral pull and insert structure of a massage head.

### BACKGROUND

Massage devices, especially handheld massagers, are widely used in our daily lives. The massage devices can relieve muscle fatigue, promote blood circulation, and relax the body and mind, and usually include massage heads that have various shapes and functions. Therefore, the massage effect on different parts and needs can be achieved.

Conventional massage heads are mostly mounted in a screw fixation manner, a snap connection manner, or a direct inserting and pulling manner. Although the screw fixation manner is firm, the mounting and removal processes are cumbersome and performed via tools. This is not convenient enough. In addition, the massage head needs to withstand a specific pressure and torque during the use. If the massage head is not firmly mounted or has poor coaxality, the massage head is easy to loosen, offset, or even fall off. This affects the user experience, and may damage the massage head.

### SUMMARY

In view of this, it is necessary to provide a spiral pull and insert structure of a massage head to resolve the above problem. The spiral pull and insert structure of a massage head includes a massage head, a sliding rod holder, and a screw, where a first groove is provided on the massage head, an end of the first groove includes a thread, a second groove is provided on the sliding rod holder, an end of the screw includes a thread, the sliding rod holder is sleeved on the massage head, the screw is disposed inside the first groove and the second groove, and a size of the screw matches a size of the first groove and a size of the second groove.

Preferably, a diameter of a portion, disposed inside the first groove, of the screw is larger than a diameter of the second groove.

Preferably, an edge of the second groove is chamfered.

Preferably, a fixing sleeve ring is sleeved on the massage head.

Preferably, at least one annular protrusion is disposed on an outer side of the fixing sleeve ring, the sliding rod holder is sleeved on the massage head, and an annular groove is provided in a region abutting against the fixing sleeve ring, and the annular groove matches the at least one annular protrusion.

Preferably, an abutting portion is disposed at a position, in contact with the massage head, of the fixing sleeve ring, and when the sliding rod holder is disposed on the massage head, an edge end of the sliding rod holder abuts against the abutting portion.

### BRIEF DESCRIPTION OF THE DRAWINGS

FIG. 1 is a schematic diagram of a structure of a spiral pull and insert structure of a massage head according to an embodiment of the present disclosure;

FIG. 2 is an exploded view of a spiral pull and insert structure of a massage head according to an embodiment of the present disclosure;

FIG. 3 is a sectional view of a spiral pull and insert structure of a massage head according to an embodiment of the present disclosure;

FIG. 4 is an enlarged view of a position A shown in FIG. 3;

FIG. 5 is a schematic diagram of a structure of a sliding rod holder according to an embodiment of the present disclosure;

FIG. 6 is a sectional view of a sliding rod holder according to an embodiment of the present disclosure;

FIG. 7 is a sectional view of a massage head according to an embodiment of the present disclosure; and

FIG. 8 is a schematic diagram of a structure of a fixing sleeve ring according to an embodiment of the present disclosure.

Reference numerals: 1: massage head; 11: first groove; 2: sliding rod holder; 21: second groove; 22: annular groove; 3: screw; 4: thread; 5: fixing sleeve ring; 51: annular protrusion; 52: abutting portion.

### DETAILED DESCRIPTION OF THE EMBODIMENTS

To make the objectives, technical solutions and the advantages of the present disclosure clearer, a spiral pull and insert structure of a massage head provided in the present disclosure is described in further detail below with reference to the drawings and embodiments. Understandably, the described embodiments are merely intended to explain the present disclosure, rather than to limit the present disclosure.

It should be understood that in the description of the present disclosure, unless otherwise specified, “a plurality of” means two or more; and terms such as “central”, “longitudinal”, “transverse”, “upper”, “lower”, “left”, “right”, “inside”, “outside”, “front”, “rear”, “head”, “tail”, “vertical”, “horizontal”, “top”, and “bottom” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, the terms “first”, “second”, and “third” are merely used for description, and are not intended to indicate or imply relative importance.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

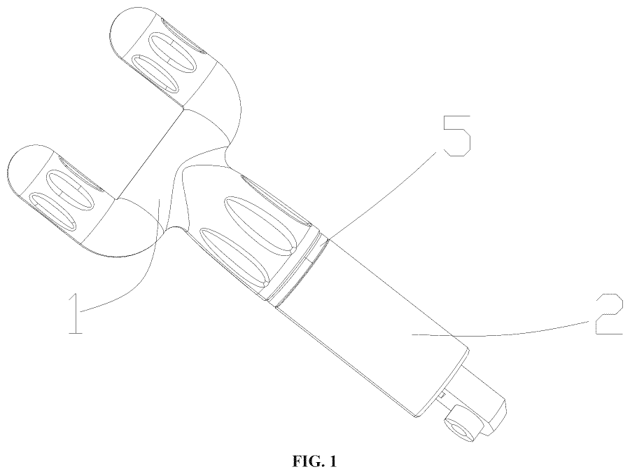

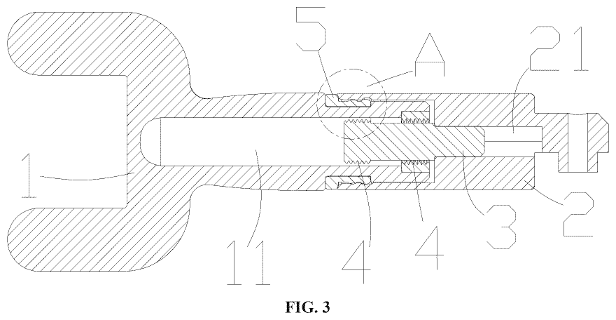

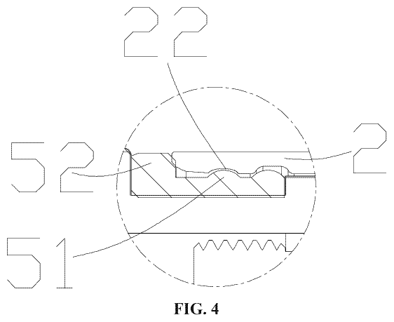

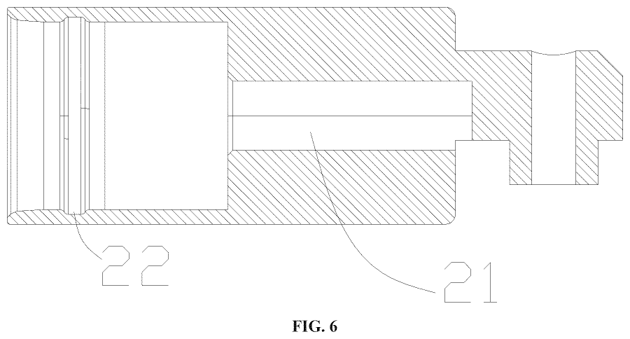

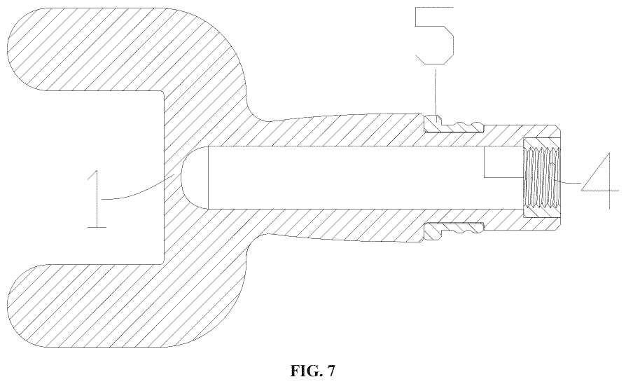

Referring to FIG. 1 to FIG. 8, a spiral pull and insert structure of a massage head 1 provided in the embodiments of the present disclosure includes a massage head 1, a sliding rod holder 2, and a screw 3. A first groove 11 is provided on the massage head 1. An end of the first groove 11 includes a thread 4. A second groove 21 is provided on the sliding rod holder 2. An end of the screw 3 includes a thread 4. The sliding rod holder 2 is sleeved on the massage head 1, and the screw 3 is disposed inside the first groove 11 and the second groove 21. A size of the screw 3 matches a size of the first groove 11 and a size of the second groove 21.

In this embodiment, the massage head 1 has a spiral pull and insert structure, including the massage head 1, the sliding rod holder 2, and the screw 3. The first groove 11 is provided in the massage head 1, and an end of the first groove 11 includes a thread 4 that is partly fitted with the thread 4 of the screw 3. The second groove 21 is provided on the sliding rod holder 2 using a smooth design, and used for inserting and fixing the non-threaded 4 portion of the screw 3.

During assembling, the screw 3 is first engaged in the second groove 21 (including but not limited to being fixed in a tight fit manner or via glue). A threaded portion of the first groove 11 is fitted with the thread of the screw by rotating the massage head, and then pushed to the bottom by screwing. Subsequently, the non-threaded 4 portion of the screw 3 is directly inserted into the second groove 21 of the sliding rod holder 2, to connect the massage head 1 to the sliding rod holder 2. Because the second groove 21 of the sliding rod holder 2 uses the smooth design, no rotation is performed in this step, and only the screw 3 needs to be pushed inward.

The massage head 1 may be removed simply. First, the sliding rod holder 2 is pulled outward until the non-threaded 4 portion of the screw 3 is completely exposed. Then, because the screw 3 is tightly fitted with the screw thread 4 of the massage head 1, the screw 3 may be separated from the massage head 1 by rotating the screw 3, to remove the massage head 1 from the sliding rod holder 2.

Therefore, the massage head 1 may be mounted and removed rapidly and conveniently, and stability and coaxality of the massage head 1 are ensured during use. Due to the smooth design of the second groove 21 of the sliding rod holder 2, a loose connection caused by the abrasion of the thread 4 is avoided, and the overall performance and service life of the spiral pull and insert structure of a massage head are improved.

Referring to FIG. 1 to FIG. 7, in another embodiment, a diameter of a portion, disposed inside the first groove 11, of the screw 3 is larger than a diameter of the second groove 21.

In this embodiment, it can be learned that the diameter of a portion, disposed inside the first groove 11, of the screw 3 is larger than the diameter of the second groove 21, and the portion, disposed inside the first groove 11, of the screw 3 abuts against the edge of the second groove 21, to play a limiting role.

Referring to FIG. 1 to FIG. 7, in another embodiment, an edge of the second groove 21 is chamfered.

In this embodiment, smoothness of insertion of the screw 3 is optimized, to reduce friction and abrasion caused by the direct contact between the edge and the screw 3.

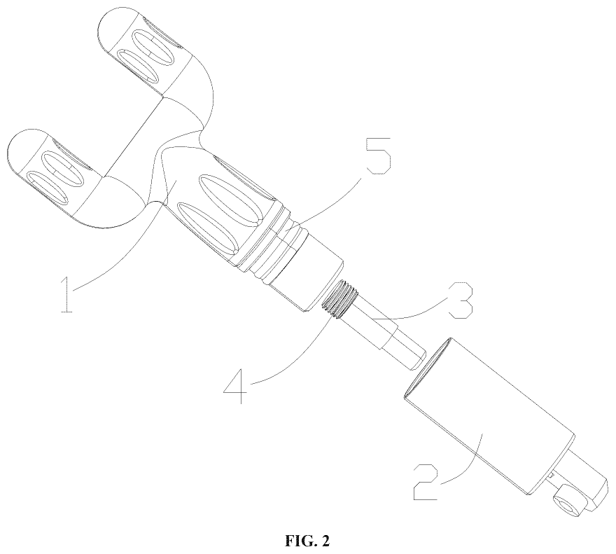

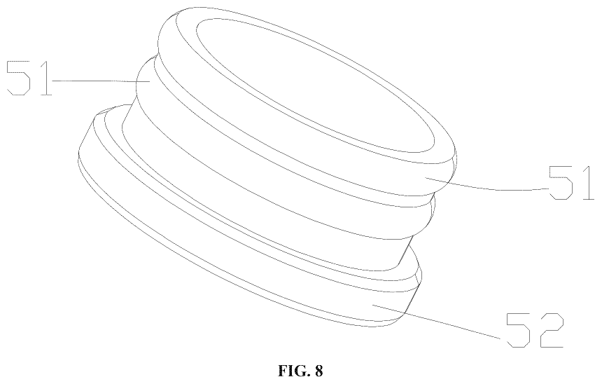

Referring to FIG. 2 and FIG. 8, in another embodiment, a fixing sleeve ring 5 is sleeved on the massage head 1.

In this embodiment, stability of a connection between the massage head 1 and the sliding rod holder 2 is enhanced.

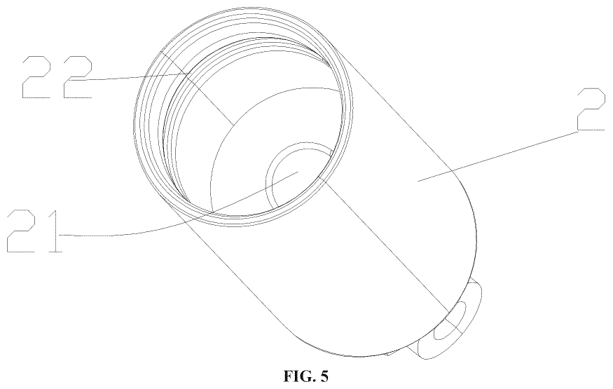

Referring to FIG. 5 to FIG. 8, in another embodiment, at least one annular protrusion 51 is disposed on an outer side of the fixing sleeve ring 5, the sliding rod holder 2 is sleeved on the massage head 1, and an annular groove 22 is provided in a region abutting against the fixing sleeve ring 5, and the annular groove 22 matches the at least one annular protrusion 51.

In this embodiment, when the sliding rod holder 2 is sleeved on the massage head 1, the annular protrusion 51 is embedded in the annular groove 22, to enhance the stability of the connection between the massage head 1 and the sliding rod holder 2.

Referring to FIG. 1 to FIG. 8, in another embodiment, an abutting portion 52 is disposed at a position, in contact with the massage head 1, of the fixing sleeve ring 5, and when the sliding rod holder 2 is disposed on the massage head 1, an edge end of the sliding rod holder 2 abuts against the abutting portion 52.

In this embodiment, a movement of the massage head 1 in an axial direction is limited. In addition, stability of the spiral pull and insert structure of a massage head is enhanced by physical contact.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A spiral pull and insert structure of a massage head, comprising a massage head, a sliding rod holder, and a screw, wherein a first groove is provided on the massage head, an end of the first groove comprises a thread, a second groove is provided on the sliding rod holder, an end of the screw comprises a thread, the sliding rod holder is sleeved on the massage head, the screw is disposed inside the first groove and the second groove, and a size of the screw matches a size of the first groove and a size of the second groove.

2. The spiral pull and insert structure of a massage head according to claim 1, wherein a diameter of a portion, disposed inside the first groove, of the screw is larger than a diameter of the second groove.

3. The spiral pull and insert structure of a massage head according to claim 1, wherein an edge of the second groove is chamfered.

4. The spiral pull and insert structure of a massage head according to claim 1, wherein a fixing sleeve ring is sleeved on the massage head.

5. The spiral pull and insert structure of a massage head according to claim 4, wherein at least one annular protrusion is disposed on an outer side of the fixing sleeve ring, the sliding rod holder is sleeved on the massage head, and an annular groove is provided in a region abutting against the fixing sleeve ring, and the annular groove matches the at least one annular protrusion.

6. The spiral pull and insert structure of a massage head according to claim 5, wherein an abutting portion is disposed at a position, in contact with the massage head, of the fixing sleeve ring, and when the sliding rod holder is disposed on the massage head, an edge end of the sliding rod holder abuts against the abutting portion.
